(19) United States
(12) Patent Application Publication
(10) Pub. No.: US 2025/0139988 A1
(43) Pub. Date: May 1, 2025

(54) OBJECT RECOGNITION APPARATUS, OBJECT RECOGNITION PROCESSING METHOD, AND RECORDING MEDIUM

(71) Applicant: SUBARU CORPORATION, Tokyo (JP)

(72) Inventors: Keiichi WATANABE, Tokyo (JP); Tsubasa ONO, Tokyo (JP); Yu YOSHIDA, Tokyo (JP)

(21) Appl. No.: 19/010,910

(22) Filed: Jan. 6, 2025

Related U.S. Application Data
(63) Continuation of application No. PCT/JP2023/014321, filed on Apr. 7, 2023.

(51) Int. Cl. G06V 20/58; G01S 13/88; G06F 3/01

(52) U.S. Cl. CPC G06V 20/58; G01S 13/88; G06F 3/013

(57) ABSTRACT

An object recognition apparatus includes: a ranging sensor that measures at least distances to reflection points based on reflected waves of applied irradiation waves; a camera that generates image data on an imaging range; and at least one processing device that performs an object recognition process based on measurement data of the ranging sensor and the image data of the camera. The device performs: detecting a line-of-sight direction of a driver of a mobile body equipped with the object recognition apparatus; setting a first range including the line-of-sight direction and a second range, in a measurement range viewed from the mobile body; and the object recognition process of performing a visual field recognition process using one of the measurement data and the image data for the first range, and performing a surrounding recognition process using another of the measurement data and the image data for the second range.

### CROSS-REFERENCE TO RELATED APPLICATIONS

This application is continuation of International Application No. PCT/JP2023/014321, filed on Apr. 7, 2023, the entire contents of which are hereby incorporated by reference.

### BACKGROUND

The disclosure relates to an object recognition apparatus, an object recognition processing method, and a recording medium.

In automated driving techniques and advanced driver assistance systems for vehicles, an object detection technique has been developed that uses an imaging device, such as a monocular camera or a stereo camera, or a ranging sensor, such as a light detection and ranging or laser imaging detection and ranging (LiDAR) or a millimeter-wave radar. The ranging sensor measures a distance based on a reflection point group that has reflected irradiation waves. In recent years, an apparatus has been proposed that detects an object by combining or fusing image data generated by an imaging device and measurement data of a ranging sensor.

For example, Japanese Unexamined Patent Application Publication (JP-A) No. 2005-090974 proposes an apparatus that recognizes a preceding vehicle in front of an own vehicle by sensor fusion, and performs image processing by a simple and small amount of calculation. Specifically, JP-A No. 2005-090974 discloses the following technique. A preceding vehicle region is determined by a preceding vehicle region determining means, based on clustering of ranging results of a scanning laser radar by a clustering processing means. A captured image of at least the preceding vehicle region of a monocular camera is processed into information on an information-compressed edge binary image by an edge image calculation processing means. The information on the edge binary image is collected as image feature value information by an edge binary image information collecting means. By comparing the information with determination reference image feature value information, a recognition determination means recognizes the preceding vehicle region as a preceding vehicle without performing complicated image processing with a large amount of calculation, such as correlation calculation or contour extraction of the captured image. A determination reference updating means updates the determination reference image feature value information, and a predicted position updating means updates prediction of a preceding vehicle position.

In addition, JP-A No. 2003-084064 proposes an apparatus that, when performing vehicle recognition using a laser radar, performs highly accurate recognition by eliminating reflections from a vehicle other than a front vehicle, a roadside object, etc. by fusing vehicle recognition by an image sensor. Specifically, JP-A No. 2003-084064 discloses the following technique. A CPU determines a reflection point group existing at substantially equidistant positions within a spread range of substantially a vehicle width as a vehicle candidate point group, based on positions of respective reflection points identified by a laser radar module. The CPU converts the vehicle candidate point group into a camera coordinate system of a CCD camera and compares it with a rectangular region extracted by a camera module. The CPU determines that the vehicle candidate point group is the front vehicle when the vehicle candidate point group after the coordinate conversion substantially matches the rectangular region.

### SUMMARY

An aspect of the disclosure provides an object recognition apparatus including a ranging sensor, a camera, and one or more processing devices. The ranging sensor is configured to measure at least distances to reflection points based on reflected waves of applied irradiation waves. The camera is configured to generate image data on an imaging range. The one or more processing devices are configured to perform an object recognition process based on measurement data of the ranging sensor and the image data of the camera. The one or more processing devices are configured to perform: a line-of-sight detection process of detecting a line-of-sight direction of a driver of a mobile body equipped with the object recognition apparatus; a range setting process of setting a first range including the line-of-sight direction and a second range other than the first range, in a measurement range viewed from the mobile body; and the object recognition process of performing a visual field recognition process using one of the measurement data and the image data for the first range, and performing a surrounding recognition process using another of the measurement data and the image data for the second range.

An aspect of the disclosure provides an object recognition processing method including: performing, with a computer, a line-of-sight detection process of detecting a line-of-sight direction of a driver of a mobile body equipped with an object recognition apparatus; performing, with the computer, a range setting process of setting a first range including the line-of-sight direction and a second range other than the first range, in a measurement range viewed from the mobile body; and performing, with the computer, an object recognition process of performing a visual field recognition process using one of measurement data of a ranging sensor and image data of a camera for the first range, and performing a surrounding recognition process using another of the measurement data and the image data for the second range, the ranging sensor being configured to measure at least distances to reflection points based on reflected waves of applied irradiation waves, the camera being configured to generate the image data on an imaging range.

An aspect of the disclosure provides a non-transitory tangible recording medium containing a computer program. The computer program causes a computer to serve as an object recognition apparatus configured to perform: a line-of-sight detection process of detecting a line-of-sight direction of a driver of a mobile body equipped with the object recognition apparatus; a range setting process of setting a first range including the line-of-sight direction and a second range other than the first range, in a measurement range viewed from the mobile body; and an object recognition process of performing a visual field recognition process using one of measurement data of a ranging sensor and image data of a camera for the first range, and performing a surrounding recognition process using another of the measurement data and the image data for the second range, the ranging sensor being configured to measure at least distances to reflection points based on reflected waves of applied irradiation waves, the camera being configured to generate the image data on an imaging range.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a schematic diagram illustrating a configuration example of a vehicle including an object recognition apparatus according to an embodiment of the disclosure.

FIG. 2 is an explanatory diagram illustrating spatial resolutions of a LiDAR and a camera.

FIG. 3 is an explanatory diagram illustrating a smallest distance at which stereo matching is possible by a stereo camera.

FIG. 4 is a block diagram illustrating a configuration example of the object recognition apparatus according to the embodiment.

FIG. 5 is a flowchart illustrating a routine of point group data processing performed by a point group data processor, of an object recognition process according to the embodiment.

FIG. 6 is a flowchart illustrating a routine of image data processing performed by an image data processor, of the object recognition process according to the embodiment.

FIG. 7 is a flowchart illustrating a routine of a first object recognition process for a short-distance region performed by an object recognition processor, of the object recognition process according to the embodiment.

FIG. 8 is a flowchart illustrating a routine of a second object recognition process for a middle-distance region and a long-distance region performed by the object recognition processor, of the object recognition process according to the embodiment.

FIG. 9 is a flowchart illustrating an object recognition processing method performed by the object recognition apparatus according to the embodiment.

FIG. 10 is a flowchart illustrating an object recognition processing method performed by the object recognition apparatus according to an embodiment of the disclosure.

FIG. 11 is a flowchart illustrating a routine of a traveling environment determination process performed by the object recognition apparatus according to the embodiment.

### DETAILED DESCRIPTION

An imaging device and a ranging sensor have different characteristics in temporal resolution (temporal resolving power) and spatial resolution (spatial resolving power). For this reason, it is difficult to make the temporal resolution and the spatial resolution of each of the imaging device and the ranging sensor variable for a recognition target distance range. In Patent Literatures 1 and 2 described above, a predetermined recognition range in which a preceding vehicle or a front vehicle exists is set as the recognition target distance range. Allowing for processing making use of the respective characteristics of the imaging device and the ranging sensor in accordance with the distance range from the vehicle makes it possible to increase object recognition accuracy around the vehicle.

The disclosure has been made in view of the above-described issue, and it is an object of the disclosure to provide an object recognition apparatus, an object recognition processing method, and a recording medium that make it possible to improve object recognition accuracy by allowing for an object recognition process making use of respective characteristics of an imaging device and a ranging sensor.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. First Embodiment

### <1-1. Overall Configuration of Object Recognition Apparatus>

First, an example of an overall configuration of a vehicle equipped with an object recognition apparatus according to an embodiment of the disclosure will be described. The vehicle serves as a mobile body. The following embodiments describe an example of the object recognition apparatus including a LiDAR as an example of a ranging sensor.

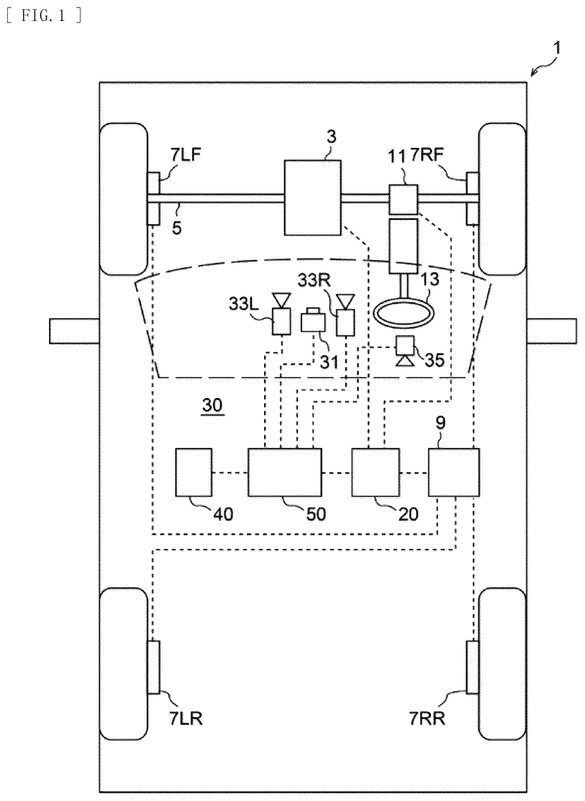

FIG. 1 is a schematic diagram illustrating a configuration example of a vehicle 1 including an object recognition apparatus 30 according to the embodiment. The vehicle 1 illustrated in FIG. 1 is configured as a front-wheel drive vehicle that transmits, to front wheels, a drive torque outputted from a drive source 3 that generates the drive torque for the vehicle. The drive source 3 may be an internal combustion engine, such as a gasoline engine or a diesel engine, or a drive motor, or may include both the internal combustion engine and the driving motor.

Note that the vehicle 1 is not limited in combination of driving wheels or driving method. For example, the vehicle 1 may be a rear-wheel drive vehicle, a four-wheel drive vehicle, or an electric vehicle including drive motors corresponding to respective wheels. When the vehicle 1 is an electric vehicle or a hybrid electric vehicle, the vehicle 1 is equipped with a secondary battery that accumulates electric power to be supplied to the drive motor, and a generator such as a motor or a fuel cell that generates electric power to be charged in the battery.

The vehicle 1 includes, as devices used to control driving of the vehicle 1, the drive source 3, an electric steering device 11, and braking devices 7LF, 7RF, 7LR, and 7RR. Hereinafter, the braking devices 7LF, 7RF, 7LR, and 7RR are collectively referred to as a “braking device 7” when it is not necessary to distinguish them from one another. The drive source 3 outputs a drive torque to be transmitted to a front wheel drive shaft 5 through a transmission and a front-wheel differential mechanism that are not illustrated. Driving of the drive source 3 and the transmission is controlled by a vehicle controller 20 including one or more electronic control units (ECUs).

The electric steering device 11 is provided on the front wheel drive shaft 5. The electric steering device 11 includes an electric motor and a gear mechanism that are not illustrated, and is controlled by the vehicle controller 20 to adjust a steering angle of the left and right front wheels. During manual driving, the vehicle controller 20 controls the electric steering device 11, based on the steering angle of a steering wheel 13 steered by a driver. Further, during automated driving, the vehicle controller 20 controls the electric steering device 11, based on a target steering angle set in accordance with a planned travel path.

The braking devices 7LF, 7RF, 7LR, and 7RR apply a braking force to a left-front wheel, a right-front wheel, a left-rear wheel, and a right-rear wheel, respectively. The braking device 7 is configured as, for example, a hydraulic braking device. Hydraulic pressure to be supplied to each braking device 7 is controlled by a hydraulic control unit 9 to thereby generate a predetermined braking force. When the vehicle 1 is an electric vehicle or a hybrid electric vehicle, the braking device 7 is used in combination with regenerative braking that uses the drive motor.

The vehicle controller 20 includes one or more electronic control units that control driving of the drive source 3, the electric steering device 11, and the hydraulic control unit 9. When the vehicle 1 includes a transmission, the vehicle controller 20 may have a function of controlling driving of the transmission. The vehicle controller 20 is configured to perform an automated driving control or an emergency braking control for the vehicle 1 by using information on an object recognized by the object recognition apparatus 30.

The object recognition apparatus 30 includes a LiDAR 31, a camera 33, a vehicle inside imaging camera 35, and a processing device 50. The LiDAR 31 and the camera 33 are installed, for example, at an upper part on a vehicle compartment side of a windshield in a vehicle compartment, or at a front part of a vehicle body, with a measurement direction or an imaging direction facing forward. The vehicle inside imaging camera 35 is installed, for example, on an instrument panel to perform imaging of at least a face of the driver of the vehicle 1.

The LiDAR 31 corresponds to an example of a “ranging sensor” that measures at least distances to reflection points based on reflected waves of applied irradiation waves. The LiDAR 31 applies laser light, i.e., optical waves, in multiple directions in front of the vehicle 1, and receives reflected light, i.e., reflected waves, of the laser light. The laser light is a type of the irradiation wave. The LiDAR 31 acquires data on positions of the reflection points in a three-dimensional space (hereinafter, also referred to as “point group data”) based on the laser light and the reflected light. The point group data of the LiDAR 31 corresponds to measurement data of the ranging sensor.

For example, the LiDAR 31 may be a time-of-flight (ToF) LiDAR that calculates the position of the reflection point in the three-dimensional space based on data on a direction from which the reflected light is received and data on a time period from the application of the laser light to the reception of the reflected light. The LiDAR 31 may calculate the position of the reflection point further based on information on intensity of the reflected light. In another example, the LiDAR 31 may be a frequency modulated continuous wave (FMCW) LiDAR that applies laser light with linearly changed frequency, and calculates the position of the reflection point in the three-dimensional space based on data on a direction from which reflected light is received and data on a phase difference between the frequency of the applied laser light and the frequency of the reflected light.

The LiDAR 31 may be what is called a scanning LiDAR that performs scanning in a horizontal direction or a vertical direction with multiple pieces of laser light arranged in a line along the vertical direction or the horizontal direction. The LiDAR 31 may be a LiDAR of a type that generates reflection point group data by applying laser light over a wide range, imaging reflected light reflected by an object by using a three-dimensional distance image sensor, and analyzing the positions of the reflection points in the three-dimensional space. The LiDAR 31 is communicably coupled to the processing device 50 by a wired or wireless communication means. The LiDAR 31 transmits the generated point group data to the processing device 50.

The point group data generated by the LiDAR 31 may be, for example, data on coordinate positions of the respective reflection points on an orthogonal triaxial three-dimensional coordinate system (also referred to as a “LiDAR coordinate system”) using the LiDAR 31 itself as an origin. When the LiDAR 31 measures a region in front of the vehicle 1, the LiDAR 31 may be installed with the three axes of the LiDAR coordinate system aligned with a front-rear direction, a vehicle-width direction, and a height direction of the vehicle 1, but the LiDAR 31 may be installed differently. The coordinate positions of the reflection points of the point group data generated by the LiDAR 31 are converted, by the processing device 50, into coordinate positions on an orthogonal triaxial three-dimensional coordinate system (also referred to as a “vehicle coordinate system”) using a predetermined position of the vehicle 1 as an origin and extending along the longitudinal direction, the vehicle width direction, and the height direction of the vehicle 1.

The LiDAR 31 typically has a fixed sum of energies that are applicable to a unit virtual plane of a space where the laser light is to be applied. For this reason, the LiDAR 31 has a characteristic that a spatial resolution decreases proportionally to a distance from a light emitting surface that issues the laser light. On the other hand, it is possible for the LiDAR 31 to extend a measurement distance by limiting an irradiation range where the laser light is to be applied, or increase the spatial resolution by reducing a frame rate, i.e., the frequency of processing per unit time.

Note that the ranging sensor is not limited to the LiDAR 31, and may be a radar sensor such as a millimeter-wave radar.

The camera 33 is an imaging device including an image sensor, such as a charged-coupled device (CCD) or a complementary metal-oxide-semiconductor (CMOS). In the embodiment, the vehicle 1 includes a pair of left and right stereo cameras 33LF and 33RF that perform imaging of a region in front of the vehicle 1. The stereo cameras 33LF and 33RF are communicably coupled to the processing device 50 by a wired or wireless communication means. The stereo cameras 33LF and 33RF transmit the generated image data to the processing device 50.

In the vehicle 1 illustrated in FIG. 1, the camera 33 is configured as the pair of left and right stereo cameras 33LF and 33RF, but may be a monocular camera including one imaging camera. The vehicle 1 may include, in addition to the front imaging camera, a camera that performs imaging of a region in the rear of the vehicle 1, or a camera that is provided on a side-view mirror, for example, to perform imaging of a left rear region or a right rear region.

The imaging direction and an angle of view that indicate an imaging range of the camera 33 are defined by, for example, an orthogonal triaxial three-dimensional coordinate system (also referred to as a “camera coordinate system”) using the camera 33 itself as an origin. When the camera 33 includes the stereo cameras 33LF and 33RF, the camera coordinate system may be a three-dimensional coordinate system using a center point between the pair of stereo cameras 33LF and 33RF as the origin. When the camera 33 measures a region in front of the vehicle 1, the camera 33 may be installed with the three axes of the camera coordinate system aligned with the front-rear direction, the vehicle-width direction, and the height direction of the vehicle 1, but the camera 33 may be installed differently. Information on the imaging range of the image data generated by the camera 33 is converted into information on the vehicle coordinate system by the processing device 50.

The camera 33 typically has a fixed number of captured images (fps: frames per second) per unit time or second. The camera 33 has a characteristic that the camera 33 is not focused and the generated image data thus has a low spatial resolution in a region closer than a focal length. The camera 33 also has a characteristic that, with a peak at the focal length, the spatial resolution on a virtual plane of a space decreases depending on a resolution of the image sensor in a region farther than the focal length. Further, in the case of the stereo cameras 33LF and 33RF, a smallest distance at which the respective pieces of image data generated by the left and right cameras are matchable (stereo-matchable) is defined additionally. The focal length or the above-described smallest distance of the camera 33 is a first distance L1, and serves as a minimum distance that allows for object recognition by an object recognition process based on the image data.

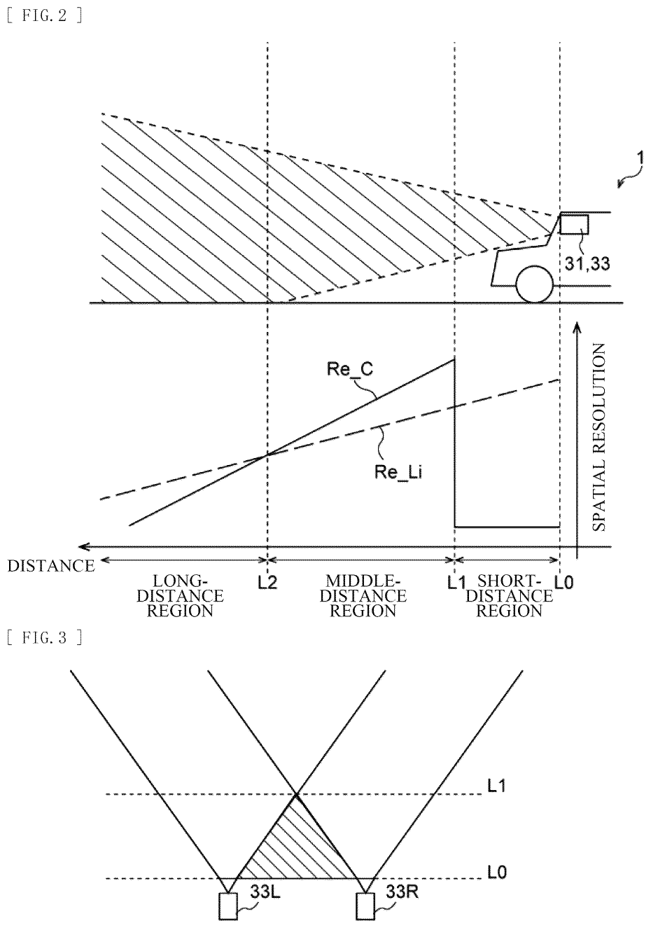

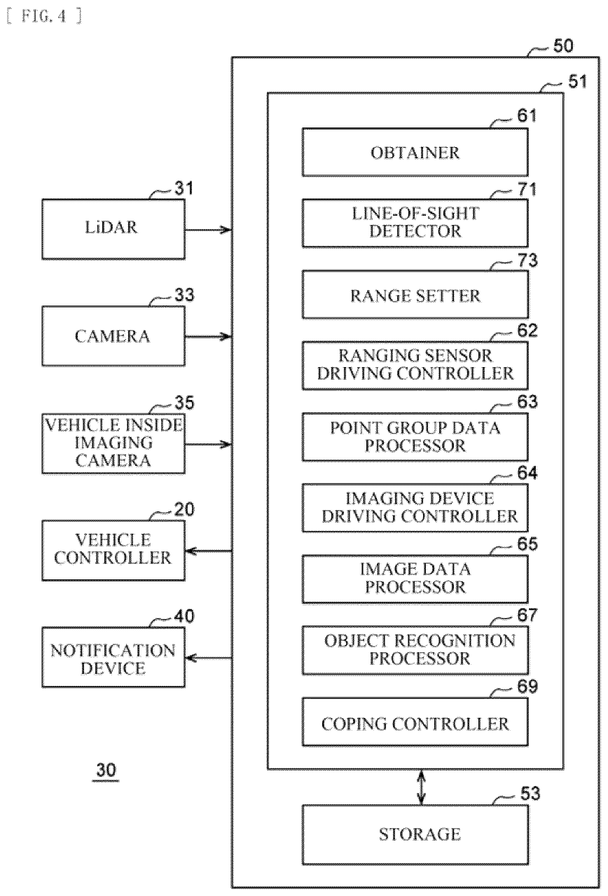

FIG. 2 is a diagram illustrating the spatial resolutions of the LiDAR 31 and the camera 33. In the illustrated example, the LiDAR 31 and the camera 33 are installed at the upper part on the vehicle compartment side of the windshield of the vehicle 1. A spatial resolution Re_C of the image data generated by the camera 33 is low in a region (hereinafter, also referred to as a “short-distance region”) from an installation position L0 of the camera 33 to the first distance L1 defined as, for example, the focal length or the smallest distance at which stereo matching is possible of the camera 33. The installation position is also referred to as a “base point”. As illustrated in FIG. 3, when the camera 33 includes the stereo cameras 33LF and 33RF, the first distance L1 is defined by the smallest distance at which the respective pieces of image data generated by the stereo cameras 33LF and 33RF are stereo-matchable. The spatial resolution Re_C of the image data generated by the camera 33 peaks at the first distance L1 and decreases proportionally as getting farther from the first distance L1.

On the other hand, a spatial resolution Re_Li of the LiDAR 31 decreases proportionally as getting farther from the installation position (base point) L0 of the LiDAR 31. In the illustrated example, the spatial resolution Re_Li of the LiDAR 31 is higher than the spatial resolution Re_C of the camera 33 in the short-distance region where the distance from the installation position (base point) L0 of the LiDAR 31 and the camera 33 is equal to or less than the first distance L1. The spatial resolution Re_Li of the LiDAR 31 and the spatial resolution Re_C of the camera 33 intersect each other at a second distance L2 farther than the first distance L1. In other words, in a region (hereinafter also referred to as “middle-distance region”) where the distance from the installation position (base point) L0 of the LiDAR 31 and the camera 33 is greater than the first distance L1 and up to the second distance L2, the spatial resolution Re_C of the camera 33 is higher than the spatial resolution Re_Li of the LiDAR 31. Further, in a region (hereinafter also referred to as “long-distance region”) where the distance from the installation position (base point) L0 of the LiDAR 31 and the camera 33 is greater than the second distance L2, the spatial resolution Re_Li of the LiDAR 31 is higher than the spatial resolution Re_C of the camera 33 again.

In the disclosure, the object recognition apparatus is configured to perform highly accurate object recognition in each of the short-distance region, the middle-distance region, and the long-distance region, based on the characteristics of the respective spatial resolutions Re_Li and Re_C of the LiDAR 31 and the camera 33 illustrated in FIG. 2.

Note that, in the embodiment, the first distance L1 described above is a boundary between the short-distance region and the middle-distance region, and the second distance L2 described above is a boundary between the middle-distance region and the long-distance region, but each of the first distance L1 and the second distance L2 may not match the boundary. In particular, the boundary between the middle-distance region and the long-distance region may be set based on accuracy of distance measurement by parallax detection by the stereo cameras 33LF and 33RF. In another example, the boundary between the middle-distance region and the long-distance region may be set based on comparison between: a minimum detection size at any distance, based on a minimum scan angle between irradiation points of the laser light, of the LiDAR 31; and a detection size corresponding to one pixel at any distance of the camera 33. In addition, the boundary between the regions may be gradually changed in a gradation or may be overlapped.

The vehicle inside imaging camera 35 is an imaging device including an image sensor, such as a CCD or a CMOS. The vehicle inside imaging camera 35 is communicably coupled to the processing device 50 by a wired or wireless communication means. The vehicle inside imaging camera 35 transmits the generated image data to the processing device 50. The vehicle inside imaging camera 35 is installed to allow the driver's face to fall within the imaging range, and the generated image data includes images of the driver's face.

The processing device 50 serves as an apparatus that recognizes an object when a processor such as one or more central processing units (CPUs) or one or more graphics processing units (GPUs) executes a computer program. The computer program is a computer program that causes the processor to execute a later-described operation to be executed by the processing device 50. The computer program to be executed by the processor may be recorded in a recording medium serving as a storage (memory) provided in the processing device 50. Alternatively, the computer program to be executed by the processor may be recorded in a recording medium built in the processing device 50 or any recording medium externally attachable to the processing device 50.

The recording medium that records the computer program may include: a magnetic medium such as a hard disk, a floppy disk, or a magnetic tape; an optical recording medium such as a CD-ROM, a DVD, or Blu-ray (registered trademark); a magneto-optical medium such as a floptical disk; a storage element such as a RAM or a ROM; a flash memory such as a USB memory or a SSD; or any other medium that is able to store programs.

The processing device 50 is coupled to the LiDAR 31, the camera 33, the vehicle inside imaging camera 35, the vehicle controller 20, and a notification device 40 via a dedicated line or via a communication means such as a controller area network (CAN) or a local internet (LIN). The notification device 40 notifies an occupant of various pieces of information by, for example, displaying an image or outputting sound, based on a drive signal generated by the processing device 50. The notification device 40 includes, for example, a display provided on the instrument panel and a speaker provided in the vehicle 1. The display may be a display of a navigation system, or a head-up display (HUD) that displays an image on the windshield.

### <1-2. Processing Device>

Next, the processing device 50 of the object recognition apparatus 30 according to the embodiment will be described in detail.

### 1-2-1. Configuration Example

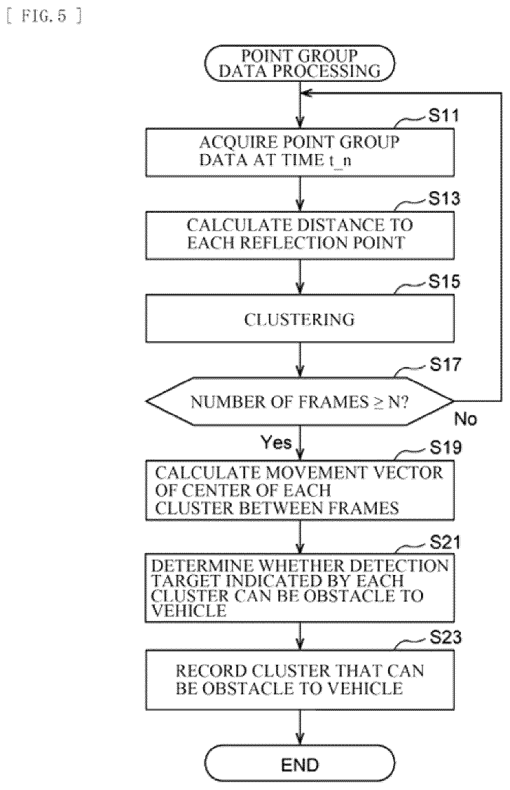

FIG. 4 is a block diagram illustrating a configuration example of the processing device 50.

The processing device 50 includes a processor 51 and a storage 53. The processor 51 includes one or more processors. Part or all of the processor 51 may include updatable software such as firmware, or may be, for example, a program module executed by a command from, for example, a CPU. Note that the processing device 50 may be configured as a single device, or may include multiple devices communicably coupled to each other.

The storage 53 includes one or more storage elements (memories) communicably coupled to the processor 51. Examples of the one or more memories include a random-access memory (RAM) and a read-only memory (ROM). Note that the storage 53 is not particularly limited in number or type. The storage 53 stores data such as a computer program to be executed by the processor 51, various parameters to be used for a calculation process, detection data, and a calculation result. A part of the storage 53 serves as a work area of the processor 51.

In addition, the processing device 50 includes one or more communication interfaces that are not illustrated and configured to transmit and receive data to and from the LiDAR 31, the camera 33, the vehicle inside imaging camera 35, the vehicle controller 20, and the notification device 40.

### 1-2-2. Configuration of Processor

The processor 51 of the processing device 50 performs the object recognition process based on the point group data transmitted from the LiDAR 31 and the image data transmitted from the camera 33. In a technique of the disclosure, the processor 51 sets, as a measurement range in which the object recognition process is to be performed, a first range including a line-of-sight direction of the driver and a second range other than the first range, and performs different object recognition processes for the ranges. In addition, the processor 51 performs the object recognition process differently for the short-distance region with low accuracy of the object recognition process based on the image data of the camera 33, and for the middle-distance region and the long-distance region in which the object recognition process based on the image data of the camera 33 is possible.

As illustrated in FIG. 4, the processor 51 of the processing device 50 includes an obtainer 61, a line-of-sight detector 71, a range setter 73, a ranging sensor driving controller 62, a point group data processor 63, an imaging device driving controller 64, an image data processor 65, an object recognition processor 67, and a coping controller 69. The obtainer 61, the line-of-sight detector 71, the range setter 73, the ranging sensor driving controller 62, the point group data processor 63, the imaging device driving controller 64, the image data processor 65, the object recognition processor 67, and the coping controller 69 are functions to be implemented by execution of a computer program by the one or more processors. Note that a part or all of the obtainer 61, the line-of-sight detector 71, the range setter 73, the ranging sensor driving controller 62, the point group data processor 63, the imaging device driving controller 64, the image data processor 65, the object recognition processor 67, and the coping controller 69 may be configured by hardware such as an analog circuit.

### (1-2-2-1. Obtainer)

The obtainer 61 acquires the point group data transmitted from the LiDAR 31 in a predetermined cycle and the image data transmitted from the camera 33 in a predetermined cycle. The point group data of the LiDAR 31 includes information on the coordinate positions of the respective reflection points on the LiDAR coordinate system. The image data of the camera 33 is image data on the imaging range generated by the image sensor.

### (1-2-2-2. Line-of-Sight Detector)

The line-of-sight detector 71 performs a line-of-sight detection process of detecting the line-of-sight direction of the driver of the vehicle 1. Specifically, the line-of-sight detector 71 detects the line-of-sight direction of the driver based on the image data generated by the vehicle inside imaging camera 35. For example, the line-of-sight detector 71 detects an eye or a pupil of the driver, converts a coordinate position on an orthogonal triaxial three-dimensional coordinate system using the vehicle inside imaging camera 35 as an origin into the coordinate position on the vehicle coordinate system, and calculates the line-of-sight direction as a vector on the vehicle coordinate system. The line-of-sight direction detection process based on the image data may be a known method. The line-of-sight detector 71 may calculate a direction in which the eye or the pupil of the driver is directed as the line-of-sight direction, or substitute a direction of the driver's face for the line-of-sight direction.

### (1-2-2-3. Range Setter)

The range setter 73 performs a range setting process of setting the first range including the line-of-sight direction of the driver and the second range other than the first range, in the measurement range in which the object recognition process is to be performed by the LiDAR 31 and the camera 33. Specifically, the range setter 73 sets the first range and the second range in the measurement range viewed from the LiDAR 31 and the camera 33, based on the position of the eye or the pupil and the line-of-sight direction of the driver detected by the line-of-sight detector 71.

The first range is set, for example, to a predetermined range around a point at which the line-of-sight direction intersects on the virtual plane at a position where the distance from the base point L0 is any distance in the middle-distance region. The first range may be set as a rectangular range, a circular range with a shape such as a perfect circle or an ellipse, or a range with any other shape. The second range is set as a range other than the first range on the above-described virtual plane. The first range and the second range may change from moment to moment in accordance with a motion of the driver's line of sight.

### (1-2-2-4. Ranging Sensor Driving Controller)

The ranging sensor driving controller 62 controls driving of the ranging sensor. In the embodiment, the ranging sensor driving controller 62 controls application of the laser light by the LiDAR 31. Specifically, the ranging sensor driving controller 62 controls an irradiation energy and an irradiation position of the laser light to be applied from the LiDAR 31. The irradiation energy and the irradiation position of the laser light may change every predetermined time period or randomly.

In the embodiment, the ranging sensor driving controller 62 sets an irradiation period of the laser light for performing the object recognition process for the short-distance region and an irradiation period of the laser light for performing the object recognition process for the middle-distance region and the long-distance region, by setting appropriate time intervals or an appropriate time ratio, and causes the laser light to be applied.

Specifically, to perform the object recognition process for the middle-distance region and the long-distance region, the ranging sensor driving controller 62 sets the minimum scan angle between the irradiation points and the irradiation energy of the laser light to be applied to the first range, of the measurement range, in which the object recognition process is to be performed based on the point group data. Limiting the irradiation range of the laser light to the first range makes it possible to increase the number of irradiation points, i.e., an irradiation density, per unit time or increase the irradiation energy of each piece of the laser light. This makes it possible to obtain high-resolution point group information.

In addition, to perform the object recognition process for the short-distance region, the ranging sensor driving controller 62 sets the minimum scan angle between the irradiation points and the irradiation energy of the laser light to be applied to the entire measurement range. When the short-distance region is a measurement target, the irradiation energy of the laser light is smaller, which makes it possible to increase the number of irradiation points, i.e., the irradiation density, per unit time. This makes it possible to obtain high-resolution point group information.

### (1-2-2-5. Point Group Data Processor)

The point group data processor 63 performs predetermined data processing based on the point group data acquired from the LiDAR 31. In the embodiment, the point group data processor 63 calculates the distance from a predetermined base point to the reflection point, for each of the reflection points included in the acquired point group data. In the embodiment, the reflection points indicate the reflection points based on a detection target existing in the first range of the measurement range. The point group data processor 63 also extracts clusters that are each a group of reflection points whose distances between the reflection points are within a predetermined distance, i.e., performs clustering. Further, the point group data processor 63 calculates, in three-dimensional maps (hereinafter, also referred to as “frames”) including the clusters extracted from the respective pieces of point group data acquired in time series, a movement vector of the center of the cluster between the frames. The center of the cluster is, for example, a coordinate position having the minimum sum of the distances from the reflection points included in the extracted cluster, but the method of calculating the center of the cluster is not particularly limited. The movement vector indicates a movement speed and a movement direction of the object configuring the cluster.

FIG. 5 is a flowchart illustrating a routine of point group data processing performed by the point group data processor 63.

The point group data processor 63 acquires the point group data at a time t_n transmitted from the LiDAR 31 (step S11). Thereafter, the point group data processor 63 calculates the distance to each of the reflection points included in the point group data (step S13). For example, the point group data processor 63 converts the coordinate position on the LiDAR coordinate system to the coordinate position on the vehicle coordinate system, for each of the reflection points, and calculates the distance from the origin of the vehicle coordinate system to each reflection point.

The vehicle coordinate system is an orthogonal triaxial three-dimensional coordinate system using the base point (L0) of distance measurement in the object recognition process as the origin and the front-rear direction, the vehicle-width direction, and the vehicle-height direction of the vehicle 1 as the three axes. The embodiment describes an example in which a center point in the vehicle-width direction at the installation position of the LiDAR 31 and the camera 33, in the front-rear direction of the vehicle 1, is used as the base point (L0), and the distance to each reflection point is calculated. However, the position of the base point may be set at any position, such as the front part of the vehicle 1.

Note that an appropriate method is used as the method of calculating the distance to each reflection point, in accordance with a type or specifications of the LiDAR 31.

Thereafter, the point group data processor 63 extracts the clusters that are each a group of reflection points whose distances between the reflection points are within the predetermined distance, as clustering (step S15). For example, the point group data processor 63 extracts the cluster by grouping, into the same group, the reflection points having a relationship in which distances between the reflection points are within a preset threshold of the processing. The point group data processor 63 generates data on the frame (the three-dimensional map) including data on the cluster in the three-dimensional space by the clustering process.

Euclidean distance is used, for example, as the distance between the reflection points, but another distance may be used. The clustering process is not limited to the above example, and any method may be used.

Thereafter, the point group data processor 63 determines whether the number of generated frames has become equal to or greater than a predetermined threshold N (step S17). The predetermined threshold N is set in advance to any value of two or more, as the number of frames in time series to be used to calculate the movement vector (the movement speed and the movement direction) of the object indicated by each of the clusters.

If it is not determined that the number of frames is equal to or greater than the predetermined threshold N (S17/No), the point group data processor 63 causes the process to return to step S11, and repeats the process of extracting the cluster from the point group data at a time t_n+1 to generate the frame.

In contrast, if it is determined that the number of frames is equal to or greater than the predetermined threshold N (S17/Yes), the point group data processor 63 calculates the movement vector of the center of the cluster of the reflection points based on the same detection target included in each frame (step S19). For example, the point group data processor 63 calculates the center of the cluster based on the coordinate positions of the multiple reflection points included in the cluster, for each of the clusters included in each frame. The point group data processor 63 also identifies the cluster of the reflection points based on the same detection target, among the clusters included in each frame, based on the position and the shape of each of the clusters included in the frames in time series, or information on the movement vectors of the clusters identified up to the previous calculation cycle.

Further, the point group data processor 63 calculates the movement vector of the center of the cluster of the reflection points based on the same detection target on the vehicle coordinate system. The movement vector has a direction indicating the movement direction of the detection target. The movement vector has a magnitude indicating a distance that the detection target has moved in a time period corresponding to a difference between acquisition times of the reflection points of the cluster included in the multiple frames. In other words, the magnitude of the movement vector indicates the movement speed of the detection target. The point group data processor 63 records data on the positions, the movement directions, and the movement speeds of the clusters obtained by the above point group data processing, in the storage 53.

Thereafter, the point group data processor 63 determines whether each of the clusters can be an obstacle to the vehicle 1 (step S21). For example, the point group data processor 63 determines that the cluster can be an obstacle to the vehicle 1 when the movement direction of the cluster intersects the planned travel path of the vehicle 1. In addition, the point group data processor 63 determines that the cluster can be an obstacle to the vehicle 1 when the cluster exists within a lane on which the vehicle 1 is traveling. The planned travel path or the lane of the vehicle 1 may be grasped based on, for example, information on a travel division line detected by the image data processor 65.

Thereafter, for the cluster determined as a cluster that can be an obstacle to the vehicle 1, the point group data processor 63 records information indicating that in the data recorded in the storage 53 (step S23). Thus, in the storage 53, the data on the clusters extracted from the point group data of the LiDAR 31 is recorded together with the information on whether each of the clusters can be an obstacle to the vehicle 1.

### (1-2-2-6. Imaging Device Driving Controller)

The imaging device driving controller 64 controls driving of the camera 33. In the embodiment, the imaging device driving controller 64 generates, every predetermined time period, the image data on the imaging range captured by the camera 33.

### (1-2-2-7. Image Data Processor)

The image data processor 65 performs predetermined data processing based on the image data acquired from the camera 33. In the embodiment, the image data processor 65 detects the travel division line, such as a lane line, based on the acquired image data.

FIG. 6 is a flowchart illustrating a routine of image data processing performed by the image data processor 65.

The image data processor 65 acquires the image data at the time t_n transmitted from the camera 33 (step S31). Thereafter, the image data processor 65 detects the travel division line based on the image data (step S33). For example, the image data processor 65 detects the traveling partition line by performing a process, i.e., an edge detection process, of detecting an edge where an amount of change in luminance in the image data exceeds a predetermined threshold, and a process, i.e., a feature point matching process, of identifying the travel division line based on a pattern of the edge. However, the method of detecting the travel division line based on the image data is not particularly limited.

In addition, the image data processor 65 determines a relative position of the travel division line with respect to the vehicle 1. When the camera 33 includes the stereo cameras 33LF and 33RF, the image data processor 65 determines the position of the travel division line on the vehicle coordinate system, based on parallax information of the respective pieces of image data generated by the left and right stereo cameras 33LF and 33RF. When the camera 33 is a monocular camera, the image data processor 65 determines the position of the travel division line on the vehicle coordinate system, based on a change in the travel division line in multiple pieces of image data acquired in time series.

Thereafter, the image data processor 65 records data on the detected travel division line in the storage 53 (step S35).

### (1-2-2-8. Object Recognition Processor)

The object recognition processor 67 performs the object recognition process by different methods for different regions, i.e., for the short-distance region and for the middle-distance region and the long-distance region. Described below are the different object recognition processes, including the first object recognition process to be performed for the short-distance region, and the second object recognition process to be performed for the middle-distance region and the long-distance region.

### (First Object Recognition Process)

In the first object recognition process for the short-distance region, the object recognition processor 67 performs a process of recognizing an object by using only the point group data acquired from the LiDAR 31. Specifically, the object recognition processor 67 recognizes the object based on a cluster (a first cluster) in the short-distance region, among the clusters extracted by the point group data processor 63. In the embodiment, the first cluster indicates the cluster in the short-distance region of the first range of the measurement range.

The short-distance region is a region in which the spatial resolution of the LiDAR 31 is higher than the spatial resolution of the camera 33 (see FIG. 2). In the short-distance region, image data that allows for object recognition by the object recognition process is not obtainable, and the stereo cameras 33LF and 33RF are not able to perform distance measurement based on the image data in a region in which stereo matching is not possible. In addition, the short-distance region is a region that is close to the vehicle 1 and in which collision avoidance, for example, is to be performed highly urgently when an object exists. For this reason, in the short-distance region, the object recognition processor 67 recognizes an object by using only the point group data of the LiDAR 31 having a higher spatial resolution.

For the short-distance region having a small distance from the vehicle 1, the object recognition processor 67 may estimate a type of the object and a distance to the object but may not estimate, for example, the movement speed or a size of the object. This allows the object recognition processor 67 to quickly detect the object, by reducing load or time for the object recognition process for the short-distance region.

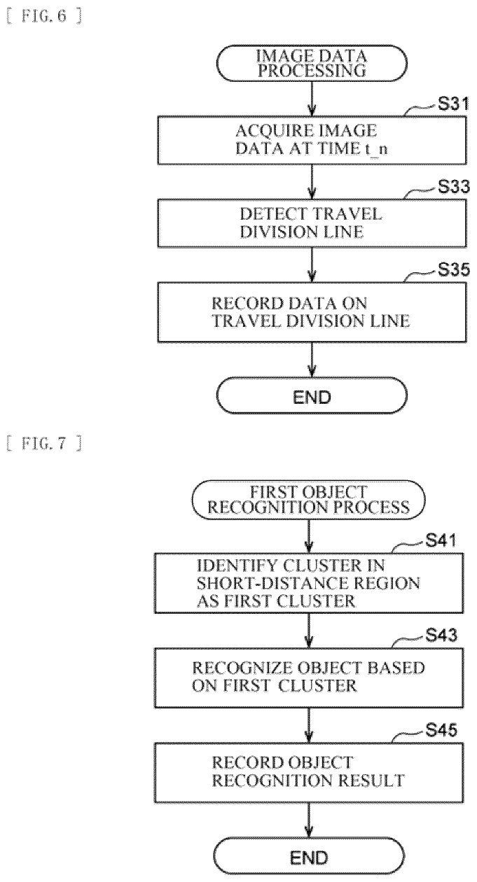

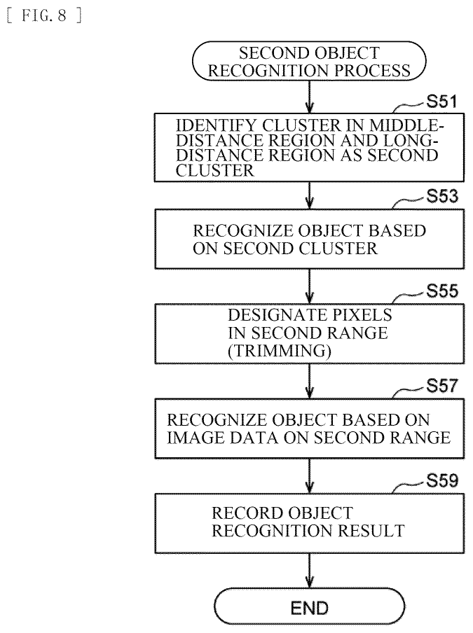

FIG. 7 is a flowchart illustrating the first object recognition process performed by the object recognition processor 67.

The object recognition processor 67 identifies the first cluster that exists in the short-distance region, among the clusters recorded as clusters that can be an obstacle to the vehicle 1 by the point group data processor 63 in step S23 described above (step S41).

For example, the object recognition processor 67 identifies, as the first cluster, a cluster whose distance from the base point L0 of the vehicle coordinate system to the center of the cluster is less than the first distance L1 set as the minimum distance that allows for object recognition by the object recognition process based on the image data. The object recognition processor 67 may set, as the first cluster, a cluster whose distance to the reflection point having the smallest distance from the base point L0 of the vehicle coordinate system, among the reflection points included in the cluster, is less than the first distance L1. Alternatively, the object recognition processor 67 may set, as the first cluster, a cluster whose distance to the reflection point having the largest distance from the base point L0 of the vehicle coordinate system, among the reflection points included in the cluster, is less than the first distance L1.

Thereafter, the object recognition processor 67 recognizes the detection target object based on the identified first cluster (step S43). For example, the object recognition processor 67 performs a pattern matching process using the first cluster to identify the type of the detection target object.

Thereafter, the object recognition processor 67 records information on an object recognition result in the storage 53 (step S45). For example, the object recognition processor 67 records, for each first cluster, information on the type of the recognized object, an existence position or direction of the object, the distance to the object, and the movement direction and the movement speed of the object. The existence position of the object may be, for example, the direction in which the center of the corresponding first cluster is positioned with respect to the origin (the base point L0) of the vehicle coordinate system. The distance to the object may be the distance to the reflection point having the smallest distance from the origin of the vehicle coordinate system, among the reflection points included in the first cluster. The movement direction and the movement speed of the object may be data on the movement vector calculated by the point group data processor 63 in step S19 described above.

### (Second Object Recognition Process)

In the second object recognition process for the middle-distance region and the long-distance region, the object recognition processor 67 performs the object recognition process using either the point group data of the LiDAR 31 or the image data of the camera 33 for each of the first range and the second range. In the embodiment, the object recognition processor 67 performs the object recognition process, i.e., a visual field recognition process, using the point group data of the LiDAR 31 for the first range of the measurement range, and performs the object recognition process, i.e., a surrounding recognition process, using the image data of the camera 33 for the second range.

The middle-distance region closer to the vehicle 1, of the middle-distance region and the long-distance region, is a region in which both the spatial resolution of the LiDAR 31 and the spatial resolution of the camera 33 are relatively high (see FIG. 2). However, because the spatial resolution of the camera 33 is higher than the spatial resolution of the LiDAR 31, the object recognition processor 67 performs the surrounding recognition process with higher accuracy using the image data of the camera 33, for the second range to which the driver is not directing the line of sight. In addition, the object recognition processor 67 complementarily performs the visual field recognition process using the point group data of the LiDAR 31, for the first range to which the driver is directing the line of sight. For example, the object recognition processor 67 uses the point group data of the LiDAR 31 to perform the object recognition process around a region to which the driver is directing the line of sight in the first range and the visual field recognition process on a region to which the driver is not directing the line of sight in the first range. Thus, even when an object exists in the range to which the driver is not directing the line of sight in the middle-distance region closer to the vehicle 1, it is possible to accurately recognize the object based on the image data of the camera 33.

FIG. 8 is a flowchart illustrating the second object recognition process performed by the object recognition processor 67.

The object recognition processor 67 identifies a second cluster that exists in the middle-distance region and the long-distance region, among the clusters recorded as clusters that can be an obstacle to the vehicle 1 by the point group data processor 63 in step S23 described above (step S51). The second cluster may be identified in a manner similar to the method of identifying the first cluster described in step S41 described above.

Thereafter, the object recognition processor 67 recognizes the detection target object based on the identified second cluster (step S53). For example, the object recognition processor 67 performs a pattern matching process using the second cluster to identify the type of the detection target object.

Thereafter, the object recognition processor 67 designates pixels corresponding to the second range in the image data (step S55). The object recognition processor 67 trims the image data in accordance with the designated pixels in the second range.

Thereafter, the object recognition processor 67 performs the object recognition process using the trimmed image data on the second range (step S57). For example, the object recognition processor 67 performs an edge detection process and a feature point matching process on the image data to identify the type of the detection target object. In addition, the object recognition processor 67 determines the distance to the detection target object and the existence position (direction) of the object, based on the image data. When the camera 33 includes the stereo cameras 33LF and 33RF, the object recognition processor 67 determines the distance to the object based on the parallax information of the respective pieces of image data generated by the left and right stereo cameras 33LF and 33RF. When the camera 33 is a monocular camera, the object recognition processor 67 determines the distance to the object based on a change in the same detection target in multiple pieces of image data acquired in time series. The object recognition processor 67 determines the existence position (direction) of the object based on a position or a range of the detection target in the image data.

In addition, the object recognition processor 67 determines the movement direction and the movement speed of the detection target object, based on a change in the distance to the detection target object and the existence position (direction) of the object determined from the pieces of image data in time series. The object recognition processor 67 calculates a relative movement direction and a relative movement speed of the detection target object with respect to the vehicle 1, from the change in the distance and the existence position of the detection target object on the vehicle coordinate system, and calculates the movement speed and the movement direction of the detection target object, based on the relative speed and the relative movement direction of the object and a speed and a movement direction of the vehicle 1.

Thereafter, the object recognition processor 67 records information on the object recognition results in steps S53 and S57 in the storage 53 (step S59). For example, the object recognition processor 67 records information on the type of each recognized object, the existence position (direction) of the object, the distance to the object, and the movement direction and the movement speed of the object.

Note that the object recognition processor 67 may perform the object recognition process of step S57 after performing super-resolution processing on the image data on the second range designated in step S55 to increase the resolution of the image data. In the long-distance region, the spatial resolution of the LiDAR 31 and the spatial resolution of the camera 33 are lower than in the middle-distance region, and the spatial resolution of the camera 33 is lower than the spatial resolution of the LiDAR 31 (see FIG. 2). Performing the super-resolution processing on the image data on the second range makes it possible to improve the accuracy of the object recognition process even in the long-distance region in which the spatial resolution of the LiDAR 31 and the spatial resolution of the camera 33 decrease.

In addition, the object recognition processor 67 may perform a labeling process for an object that has been recognized once in the object recognition process for each of the short-distance region, the middle-distance region, and the long-distance region, and perform a process of tracing the object by using the LiDAR 31 or the camera 33 from then on. The labeling process is a process of associating information on the object with recognized information. The object recognition processor 67 may thus omit the process of estimating, for example, the type and the size of the object. This makes it possible to reduce the load of the calculation process by the processing device 50.

### (1-2-2-9. Coping Controller)

The coping controller 69 performs a predetermined control to cope with the recognized object, based on the result of the object recognition process performed by the object recognition processor 67. For example, the coping controller 69 transmits information on the object recognition result to the vehicle controller 20 for avoidance of contacting or approaching the recognized object. The information on the object recognition result includes information on one or more of the type, the position, the movement speed, and the movement direction of the object recorded in the storage 53. The vehicle controller 20 performs the emergency braking control or an automatic steering control to avoid contacting or approaching the object.

Alternatively, the coping controller 69 drives the notification device 40 to notify the driver of the existence of the object for avoidance of contacting or approaching the recognized object. For example, the coping controller 69 may notify the driver of, for example, the type or the position of the object, or advice for a driving operation to avoid contacting or approaching, by one or both of sound and display.

### <1-3. Object Recognition Processing Method>

Next, an object recognition processing method performed by the processing device 50 of the object recognition apparatus 30 according to the embodiment will be described.

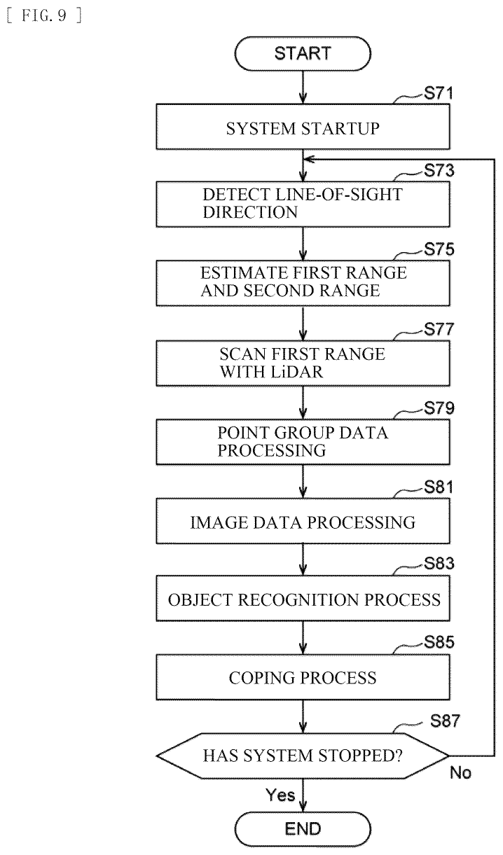

FIG. 9 is a flowchart illustrating the object recognition processing method. The flowchart described below may be executed at all times while a system of the vehicle 1 is in operation, or may be executed while an object recognition system is in operation.

When the processor 51 of the processing device 50 detects a startup of the system (step S71), the line-of-sight detector 71 detects the line-of-sight direction of the driver based on the image data of the vehicle inside imaging camera 35 (step S73). Specifically, the line-of-sight detector 71 calculates the position of the eye or the pupil and the line-of-sight direction of the driver, as the coordinate position and the vector on the vehicle coordinate system.

Thereafter, the range setter 73 sets the first range including the line-of-sight direction of the driver and the second range other than the first range, in the measurement range in which the object recognition process is to be performed by the LiDAR 31 and the camera 33 (step S75). For example, the range setter 73 sets the first range to the predetermined range around the point at which the line-of-sight direction intersects on the virtual plane at the position where the distance from the base point L0 is any distance in the middle-distance region. The range setter 73 sets the range other than the first range on the above-described virtual plane as the second range.

Thereafter, the ranging sensor driving controller 62 controls the driving of the LiDAR 31 to apply the laser light to the first range set by the range setter 73 (step S77). Specifically, the ranging sensor driving controller 62 sets the irradiation energy, the minimum scan angle between the irradiation points, a scanning speed, and the irradiation range of the laser light in accordance with the first range, and causes the LiDAR 31 to apply the laser light, as the laser light for performing the object recognition process for the middle-distance region and the long-distance region.

Note that the ranging sensor driving controller 62 causes the laser light for performing the object recognition process for the middle-distance region and the long-distance region to be applied at predetermined time intervals or a predetermined time ratio with respect to the laser light for performing the object recognition process for the short-distance region. The irradiation energy, the minimum scan angle between the irradiation points, the scanning speed, and the irradiation range of the laser light for performing the object recognition process for the short-distance region are set in advance, and the ranging sensor driving controller 62 causes the laser light to be applied at predetermined time intervals or a predetermined time ratio to the entire range of the measurement range.

Thereafter, the point group data processor 63 performs the point group data processing illustrated in FIG. 5, based on the point group data measured by the LiDAR 31 (step S79). The clusters that can be an obstacle to the vehicle 1 are extracted by the point group data processing.

Thereafter, the image data processor 65 performs the image data processing illustrated in FIG. 6, based on the image data generated by the camera 33 (step S81).

Thereafter, the object recognition processor 67 performs the first object recognition process illustrated in FIG. 7 and the second object recognition process illustrated in FIG. 8 for the short-distance region and for the middle-distance region and the long-distance region, respectively (step S83). As described above, the short-distance region for which the first object recognition process is performed is a region with low accuracy of object recognition or distance measurement based on the image data of the camera 33. For this reason, the object recognition process is performed based on the point group data of the LiDAR 31 having a higher spatial resolution for the short-distance region.

In addition, the middle-distance region and the long-distance region for which the second object recognition process is performed are regions in which it is possible to perform both the object recognition process based on the point group data of the LiDAR 31 and the object recognition process based on the image data of the camera 33. In the embodiment, the visual field recognition process is complementarily performed based on the point group data of the LiDAR 31, for the first range including the line-of-sight direction of the driver, of the middle-distance region and the long-distance region. In addition, the surrounding recognition process is performed based on the image data of the camera 33, for the second range other than the first range. This makes it possible to recognize, with high accuracy, the object that can fall outside the driver's visual field.

Consequently, the object recognition process that makes use of the characteristics of the LiDAR 31 and the camera 33 is performed in each of at least the middle-distance region and the long-distance region, which makes it possible to increase the accuracy of the result of the object recognition process. In addition, the object recognition process based on the point group data of the LiDAR 31 is performed in the short-distance region, which makes it possible to complement object recognition in the region in which the accuracy of the object recognition by the camera 33 decreases.

Thereafter, the coping controller 69 performs one or both of a notification process for avoiding contacting or approaching the object and a process of transmitting the information on the object recognition result to the vehicle controller 20, based on the result of the object recognition process (step S85).

Thereafter, the processor 51 determines whether the system has stopped (step S87). If it is not determined that the system has stopped (S87/No), the processor 51 causes the process to return to step S73 and repeats the object recognition process. In contrast, if it is determined that the system has stopped (S87/Yes), the processor 51 ends the process.

As described above, the object recognition apparatus 30 according to the embodiment performs the object recognition process for the middle-distance region and the long-distance region where the distance from the predetermined base point L0 is greater than the first distance L1, in different manners in the first range including the line-of-sight direction of the driver and in the second range other than the first range. This makes it possible to improve object recognition accuracy in each region by making use of the respective characteristics of the LiDAR 31 and the camera 33.

Specifically, the object recognition apparatus 30 complementarily performs the visual field recognition process based on the point group data of the LiDAR 31, for the first range including the line-of-sight direction of the driver. Limiting the irradiation range of the laser light to be applied from the LiDAR 31 makes it possible to increase the irradiation density of the laser light or increase the irradiation energy of each piece of the laser light. This allows object recognition in the first range to be accurately performed, making it possible to complement visual recognition by the driver.

The surrounding recognition process is performed based on the image data of the camera 33, for the second range other than the first range. This makes it possible to recognize, with high accuracy, the object that can fall outside the driver's visual field. In addition, separating the range in which the object recognition process based on the point group data of the LiDAR 31 is to be performed from the range in which the object recognition process based on the image data of the camera 33 is to be performed makes it possible to reduce the load imposed on the processing device 50 for the object recognition process.

In addition, the object recognition apparatus 30 according to the embodiment may perform the super-resolution processing on the image data, and thereafter perform the object recognition process based on the image data. Thus, even in the long-distance region, the object recognition process is performed for the second range based on the image data having a resolution higher than the spatial resolution of the LiDAR 31, which makes it possible to improve the object recognition accuracy.

In addition, the object recognition apparatus 30 according to the embodiment performs the object recognition process based on the point group data of the LiDAR 31, in the short-distance region less than the first distance L1 in which the object recognition accuracy by the object recognition process based on the image data of the camera 33 is low. Consequently, in the region with low accuracy of object recognition by the camera 33, for example, distance recognition is performed based on the point group data of the LiDAR 31, allowing for highly urgent coping such as a notification operation or an avoidance operation.

### 2. Second Embodiment

Next, a second embodiment of the disclosure will be described.

To perform the object recognition process for the short-distance region in which the recognition accuracy by the object recognition process based on the image data of the camera 33 decreases, the object recognition apparatus 30 according to the first embodiment applies the laser light to be applied for the object recognition process in the short-distance region to the entire range of the measurement range. In contrast, the object recognition apparatus according to the second embodiment limits also the laser light to be applied for the object recognition process in the short-distance region to the range including the line-of-sight direction of the driver.

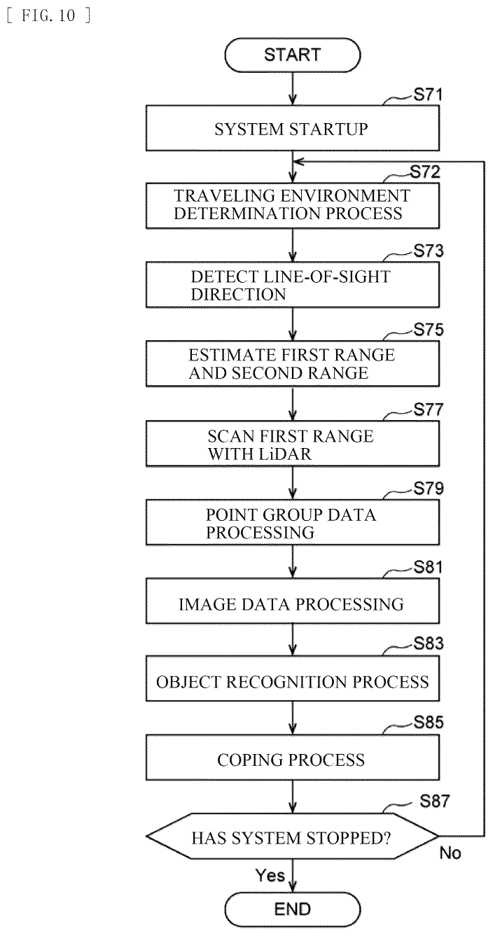

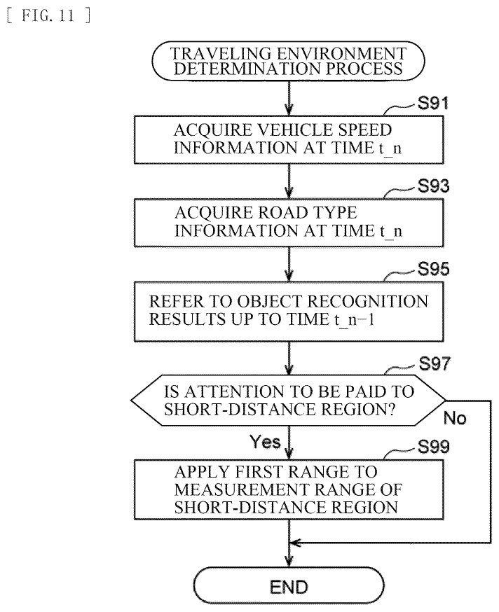

FIG. 10 is a flowchart illustrating an object recognition processing method performed by the processing device 50 of the object recognition apparatus 30 according to the second embodiment. The flowchart illustrated in FIG. 10 additionally includes a traveling environment determination process (step S72) in the flowchart illustrated in FIG. 9.

When the processor 51 of the processing device 50 detects a startup of the system (step S71), the range setter 73 performs the traveling environment determination process of determining whether the vehicle 1 is in a situation of high necessity for object recognition in the short-distance region, based on information on a traveling environment of the vehicle 1 (step S72). For example, the range setter 73 determines whether the vehicle 1 is placed in a traveling environment estimated to include a large number of objects that can be an obstacle to the vehicle 1 within a small distance range from the vehicle 1. When it is determined that the vehicle 1 is in the situation of high necessity for object recognition in the short-distance region, the range setter 73 concentrates resources of the object recognition process by the LiDAR 31 on the range including the line-of-sight direction of the driver also in the short-distance region.

FIG. 11 is a flowchart illustrating an example of the traveling environment determination process.

The range setter 73 acquires information on a vehicle speed of the vehicle 1 at the time t_n (step S91). The information on the vehicle speed may be a sensor signal of a vehicle speed sensor or may be acquired from another control unit having the information on the vehicle speed.

Thereafter, the range setter 73 acquires road type information at the time t_n (step S93). The road type information is information indicating a type of a road on which the vehicle 1 is traveling, and is recorded in, for example, map data. Examples of the information on the type of the road may include information on one or more of the following: a residential road, a shopping district, a main road, a city highway, an inter-city highway, a school route, a road width, whether there is a sidewalk, whether there is a guardrail, whether there is a curb, and time of passage, i.e., a current time. The range setter 73 may determine whether the road on which the vehicle 1 is traveling is an environment with a large number of pedestrians or bicycles, or a narrow road, for example, based on the road type information.

For example, the range setter 73 acquires the information on the type of the road recorded in the map data, based on a traveling position of the vehicle 1 and the map data. The traveling position is identified by a position detecting sensor, such as a GPS sensor. The range setter 73 may acquire the information on the type of the road on which the vehicle 1 is traveling by communication with another vehicle or an external system.

Thereafter, the range setter 73 acquires information on the results of the object recognition process up to the previous calculation cycle at a time t_n−1 (step S95). Specifically, the range setter 73 reads the information on the result of the object recognition process recorded in the storage 53.

Thereafter, the range setter 73 determines whether the traveling environment of the vehicle 1 is a traveling environment in which attention is to be paid to the short-distance region (step S97). For example, the range setter 73 determines that attention is to be paid to the short-distance region in the traveling environment, when it is determined that the vehicle 1 is traveling in a shopping district with a large number of pedestrians or bicycles, or when it is determined that the vehicle 1 is traveling on a school route during commute time to and from school. However, the method of determining whether the traveling environment of the vehicle 1 is the traveling environment in which attention is to be paid to the short-distance region is not limited to the above-described examples.

If it is determined that the traveling environment of the vehicle 1 is the traveling environment in which attention is to be paid to the short-distance region (S97/Yes), the range setter 73 records that the first range including the line-of-sight direction of the driver is to be applied also to the measurement range of the short-distance region (S99), and ends the traveling environment determination process. In contrast, if the range setter 73 does not determine that the traveling environment of the vehicle 1 is the traveling environment in which attention is to be paid to the short-distance region (S97/No), the range setter 73 directly ends the traveling environment determination process.

Returning to FIG. 10, after performing the traveling environment determination process, the processor 51 performs the processes of step S73 and the subsequent steps of the flowchart illustrated in FIG. 9. In this case, if it is not determined that the traveling environment of the vehicle 1 is the traveling environment in which attention is to be paid to the short-distance region (S97/No) in step S72, the processor 51 performs the processes of step S73 and the subsequent steps along the procedure performed by the object recognition apparatus 30 according to the first embodiment.

In contrast, if it is determined that the traveling environment of the vehicle 1 is the traveling environment in which attention is to be paid to the short-distance region (S97/Yes) in step S72, the processor 51 concentrates the resources of the object recognition process by the LiDAR 31 on the first range also in the first object recognition process for the short-distance region.

Specifically, after the line-of-sight direction of the driver is detected and the first range and the second range are set in the measurement range in steps S73 and S75, the ranging sensor driving controller 62 limits also the laser light to be applied for performing the object recognition process (the visual field recognition process) for the short-distance region in step S77 to the first range, and causes the laser light to be applied. This makes it possible to increase the irradiation density of the laser light for performing the object recognition process for the short-distance region, or increase the irradiation energy of each piece of the laser light.

In this case, the first cluster identified by the first object recognition process illustrated in FIG. 7 is a cluster of reflection points based on the detection target existing in the first range of the short-distance region, and the object recognition process is performed based on the first cluster measured with high accuracy. Consequently, when a risk level is high in the short-distance region in which the object recognition process using the image data has low accuracy, it is possible to particularly increase the object recognition accuracy in the first range to which the driver is directing the line of sight, making it possible to improve responsiveness of, for example, the notification process and the automated driving control process for the vehicle.

Note that, in the embodiment, if a result of determining the traveling environment of the vehicle 1 indicates a situation in which the vehicle speed of the vehicle 1 is low and it suffices to pay attention to the short-distance region, the resources of the LiDAR 31 for the first range may be concentrated only on the short-distance region, and only the object recognition process based on the image data for the second range may be performed for the middle-distance region and the long-distance region.

Alternatively, the ranging sensor driving controller 62 may cause the laser light for performing the object recognition process for the middle-distance region and the long-distance region to be applied at predetermined time intervals or a predetermined time ratio with respect to the laser light for performing the object recognition process for the short-distance region.

### 3. Third Embodiment

Next, a third embodiment of the disclosure will be described.

The object recognition apparatus 30 according to the first embodiment is configured to, in the object recognition process in the middle-distance region and the long-distance region, perform the visual field recognition process using the point group data of the LiDAR 31 for the first range including the line-of-sight direction of the driver, and perform the surrounding recognition process using the image data of the camera 33 for the second range other than the first range.

In contrast, the object recognition apparatus according to the third embodiment is configured to, in the object recognition process in the middle-distance region and the long-distance region, perform the visual field recognition process using the image data of the camera 33 for the first range including the line-of-sight direction of the driver, and perform the surrounding recognition process using the point group data of the LiDAR 31 for the second range other than the first range.

The object recognition apparatus according to the embodiment performs the object recognition process for the middle-distance region and the long-distance region where the distance from the predetermined base point L0 is greater than the first distance L1, in different manners in the first range including the line-of-sight direction of the driver and in the second range other than the first range. Specifically, the object recognition apparatus performs the visual field recognition process based on the image data of the camera 33 for the first range including the line-of-sight direction of the driver. This makes it possible to recognize, with high accuracy, the object existing in the direction in which the driver's line of sight is directed and to which the driver is paying attention.

In addition, the object recognition apparatus according to the embodiment may perform the super-resolution processing on the image data, and thereafter perform the object recognition process based on the image data. Thus, even in the long-distance region, the visual field recognition process is performed for the first range based on the image data having a resolution higher than the spatial resolution of the LiDAR 31, which makes it possible to improve the object recognition accuracy.

In addition, for the second range other than the first range, the surrounding recognition process is complementarily performed based on the point group data of the LiDAR 31. Limiting the irradiation range of the laser light to be applied from the LiDAR 31 makes it possible to increase the irradiation density of the laser light or increase the irradiation energy of each piece of the laser light. This allows object recognition to be accurately performed even in the range to which the driver is not directing the line of sight, making it possible to complement the visual recognition by the driver. In addition, separating the range in which the object recognition process based on the point group data of the LiDAR 31 is to be performed from the range in which the object recognition process based on the image data of the camera 33 is to be performed makes it possible to reduce the load imposed on the processing device 50 for the object recognition process.

In addition, the object recognition apparatus 30 according to the embodiment performs the object recognition process based on the point group data of the LiDAR 31, in the short-distance region less than the first distance L1 in which the object recognition accuracy by the object recognition process based on the image data of the camera 33 is low. Consequently, in the region with low accuracy of object recognition by the camera 33, for example, distance recognition is performed based on the point group data of the LiDAR 31, allowing for highly urgent coping such as a notification operation or an avoidance operation. In this case, the resources of the LiDAR 31 may be concentrated on the first range including the line-of-sight direction of the driver also in the short-distance region, as described in the second embodiment.

Although preferred embodiments of the disclosure have been described in the foregoing with reference to the accompanying drawings, the disclosure is by no means limited to such embodiments. It should be appreciated that various modifications and alterations may be made by persons skilled in the art without departing from the scope as defined by the appended claims. The disclosure is intended to include such modifications and alterations in so far as they fall within the scope of the appended claims.

For example, in the above-described embodiment, the short-distance region and the middle-distance region, and the middle-distance region and the long-distance region are clearly defined at the boundaries, and the predetermined process is performed in each region, but the technique of the disclosure is not limited to such an example. For example, when the distance to the detected object changes across the short-distance region and the middle-distance region or across the middle-distance region and the long-distance region, the region may be gradually changed or overlapped near the boundary between the regions. This makes it possible to prevent the result of the object recognition process from becoming unstable due to a sudden change in the object recognition processing method.

According to the disclosure as described above, it is possible to improve object recognition accuracy by making use of respective characteristics of an imaging device and a ranging sensor.

1. An object recognition apparatus comprising:
a ranging sensor configured to measure at least distances to reflection points based on reflected waves of applied irradiation waves;
a camera configured to generate image data on an imaging range; and
one or more processing devices configured to perform an object recognition process based on measurement data of the ranging sensor and the image data of the camera, wherein
the one or more processing devices are configured to perform
a line-of-sight detection process of detecting a line-of-sight direction of a driver of a mobile body,
a range setting process of setting a first range including the line-of-sight direction and a second range other than the first range, in a measurement range viewed from the mobile body, and
the object recognition process of performing a visual field recognition process using one of the measurement data and the image data for the first range, and performing a surrounding recognition process using another of the measurement data and the image data for the second range.

2. The object recognition apparatus according to claim 1, wherein
the one or more processing devices are configured to
further perform a traveling environment determination process of determining, based on information on a traveling environment of the mobile body, whether the mobile body is in a situation of high necessity for object recognition in a short-distance region less than a minimum distance that allows for the object recognition by the object recognition process based on the image data, and
perform the visual field recognition process using the measurement data for the first range including the line-of-sight direction in the object recognition process, when the one or more processing devices determine that the mobile body is in the situation of high necessity for the object recognition in the short-distance region.

3. An object recognition processing method comprising:
performing, with a computer, a line-of-sight detection process of detecting a line-of-sight direction of a driver of a mobile body;
performing a range setting process of setting a first range including the line-of-sight direction and a second range other than the first range, in a measurement range viewed from the mobile body; and
performing, with the computer, an object recognition process of performing a visual field recognition process using one of measurement data of a ranging sensor and image data of a camera for the first range, and performing a surrounding recognition process using another of the measurement data and the image data for the second range, the ranging sensor being configured to measure at least distances to reflection points based on reflected waves of applied irradiation waves, the camera being configured to generate the image data on an imaging range.

4. A non-transitory tangible recording medium containing a computer program, the computer program causing a computer to perform:
a line-of-sight detection process of detecting a line-of-sight direction of a driver of a mobile body;
a range setting process of setting a first range including the line-of-sight direction and a second range other than the first range, in a measurement range viewed from the mobile body; and
a surrounding recognition process of performing a visual field recognition process using one of measurement data of a ranging sensor and image data of a camera for the first range, and performing a surrounding recognition process using another of the measurement data and the image data for the second range, the ranging sensor being configured to measure at least distances to reflection points based on reflected waves of applied irradiation waves, the camera being configured to generate the image data on an imaging range.
